(19) United States
(12) Patent Application Publication
(10) Pub. No.: US 2020/0320912 A1
(43) Pub. Date: Oct. 8, 2020

(54) LIGHTED IMAGE DISPLAY ASSEMBLY

(71) Applicant: Maria Schneider, Gladwyne, PA (US)

(72) Inventor: Maria Schneider, Gladwyne, PA (US)

(21) Appl. No.: 16/839,038

(22) Filed: Apr. 2, 2020

Related U.S. Application Data
(60) Provisional application No. 62/827,912, filed on Apr. 2, 2019.

(51) Int. Cl. G09F 13/18; G09F 19/12

(52) U.S. Cl. CPC G09F 13/18; G09F 2013/1886; G09F 19/12

(57) ABSTRACT

Disclosed herein is an image display assembly comprising a frame configured with a groove system comprising one or more grooves or channels of varying depths and thicknesses, for securing a plurality of image sheets, wherein the image sheets may be of like or varying materials and thicknesses. Also disclosed is a method of manufacturing an image display assembly, comprising, etching an image onto a first acrylic sheet; applying a painted layer to at least one of a second and third acrylic or Plexiglas sheet, wherein the first, the sheets are commensurate in size; assembling the plurality of layers of sheets into a frame, wherein the frame has a series of channels disposed within the interior of the frame, so that each of the layers is secured within a channel; and a light source secured within the first channel of the frame in order to light the image display.

### BACKGROUND

The modes of artistic self-expression have changed with the use of new technologies. These new technologies present new challenges and opportunities. The use of lasers as instruments of drawing and LEDs (light-emitting diodes) allow to present art in new ways. Until this point there were only image display assemblies that contained single layer images. There were no image display assemblies able to accommodate multiple images, let alone have them illuminated all the way around by a hidden light source, to provide depth of expression.

### SUMMARY

Disclosed herein is an image display assembly comprising a frame configured with a groove system comprising one or more grooves or channels of varying depths and thicknesses, for securing a plurality of image display sheets therein, wherein the image sheets may be of like or varying materials and thicknesses. Also disclosed is a method of manufacturing an image display assembly, comprising, etching an image onto a first acrylic sheet; applying a painted layer to at least one of a second and third acrylic or Plexiglas sheet, wherein the first, the sheets are commensurate in size; assembling the plurality of layers of sheets into a frame, wherein the frame has a series of channels disposed within the interior of the frame, so that each of the layers is secured within a channel into the frame; and a light source secured within the first channel of the frame in order to light the image display.

The present invention provides a presentation of physical juxtaposed images to create a narrative, comprising three layers of drawings laser etched on acrylic or plexiglass sheets juxtaposed—but not touching each other, requiring each one to be secured in their own channel, or groove.

There was a need for an image display assembly that would accommodate three layers of acrylic or Plexiglass of varying thickness and that would also allow an embedded light source, such as an LED strip. Ideally the light source should be hidden inside the assembly, and the cables that connect it to the electric source must be hidden from plain view. The assembly requires that one of the channels is deep enough to accommodate this LED strip and also the assembly should be deep enough to hide all the wiring required to connect the strip to an electric source.

The present invention provides an image display assembly configured to accommodate multiple laser etched and/or painted image acrylic sheets, each one secured in its groove with the front image illuminated by LEDs embedded in the assembly. The assembly is configured to allow otherwise hidden or invisible images (those etched onto the clear image sheets) to become visible. The assembly can be secured to a wall or structure and will hide all the electrical elements.

### BRIEF DESCRIPTION OF THE FIGURES

FIG. 1 shows an exemplary lighted image display according to one embodiment of the invention.

FIG. 2 shows a side view of the lighted image display and engagement with a hanging mechanism, according to one embodiment of the intention.

FIG. 3 shows a detailed rear view of the lighted image display according to one embodiment of the invention, showing a cleat arrangement for securing the assembly to the wall for display and a dado created within the frame for securing light source cables.

FIG. 4 shows cross-sectional views of the frame, showing the plurality of channels into which the panels are inserted, and the light source within a channel.

FIG. 5 shows a plurality of panels according to one embodiment of the invention, including as one embodiment two transparent to semi-transparent sheets (103, 104) and an opaque sheet 105.

### DETAILED DESCRIPTION OF THE INVENTION

Described herein is a lighted image display assembly, comprising a frame configured with a plurality of channels along the inner surface of the frame into which a plurality of artwork panels, or alternately referred to as sheets, are installed. In one embodiment, the frame comprises a plurality of channels on the inner surface configured to secure the image display sheets; and a light source secured in at least one of the plurality of channels. In one embodiment, the frame is a thickness ranging from 3.5 inches to 4 inches. The channels are a thickness commensurate with the acrylic sheets, and may each be of a differing thickness depending on the nature of material, or the artistic image disposed thereon. For example, a panel with laser etching may be of a thicker material than a sheet with a painted image thereon.

In one embodiment, the plurality of image panels comprise three layers: a first transparent layer, a second transparent layer and a third layer, the first layer being an outer facing layer, the second layer being disposed between the first and third layer, and the third layer being an opaque layer oriented to the back of the image display. The opaque layer is made through the selection of materials or by application of paint. In another embodiment, the plurality of layers is separated by at least 0.15 inches up to 0.5 inches, between the layers.

In one embodiment, the first layer has disposed on a first surface of the image sheet a laser cut image etched/engraved onto the image sheet. The image is formed by converting a hand drawn or computer generated (such as Photoshop or Illustrator) image into a series of vectors corresponding to the image for translation of the image onto the image sheet. The etching ranges from 0.001 inches to approximately 0.05 inches into the Plexiglas.

In one embodiment, one of the first image sheet or second image sheet comprises a sheet of acrylic or Plexiglas, and is covered with a protective layer (such as tape, paper, or other removable adhesive), that is removed after the laser cut image is applied. Sheets may be of varying thickness, and in one embodiment, a sheet has a thickness of 1/16 to ¼ inch.

In one embodiment, the light source for the lighted image display is an LED strip of lights, which are secured into the channel of the frame, between the frame and the first image layer, so that the LED lighting illuminates the first image display sheet making visible the image as the light illuminates it.

In one embodiment, the assembly comprises three layers secured within a frame, the assembly comprising: a first transparent layer and a second transparent layer, the first layer comprising an etched image, and a third layer, the third layer being opaque, or colored; and wherein between the third layer and the back edge of the frame is an open space; behind the open space wires may be secured for the LED lights; and wherein the back edge of the frame is flush with the wall when installed and mounted on a wall for display. On the back of the frame is a cleat that secures to the frame and to the wall.

In one embodiment, sheets are made of acrylic material, such as Plexiglas. The first and second sheets are transparent and display either an etched image or an etched and displays and etched painted image painted image; a third layer is opaque and forms a back panel of the image display. In one embodiment, the painted image is made of an oil-based paint with high luminosity and gloss.

Also disclosed are photographic images of the image display, showing the following features: frame with inner channels for securing a plurality of image sheets; image sheets comprising one or more images (painted and etched by laser); light source (LED light strip); cleat member for securing image display to a wall for display.

The overall dimensions of the image display may vary; the thickness of the frame (from back to front of each side) is a minimum of 3 inches; however, the length and width of the image sheets, and the corresponding dimensions of the frame are variable.

In one embodiment, the frame is comprised of wood or wood composite, metals or plastics.

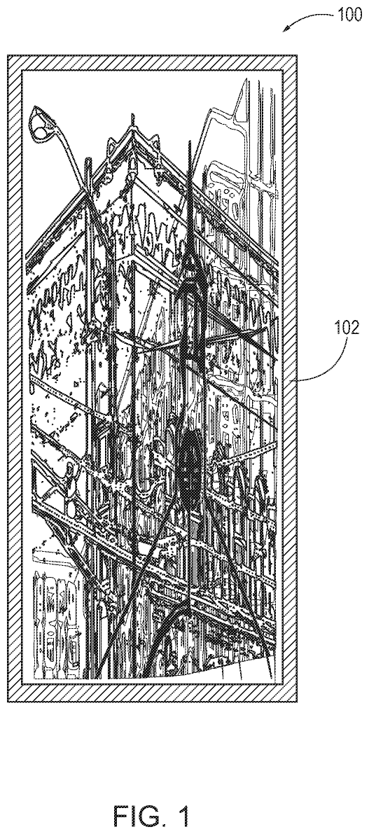

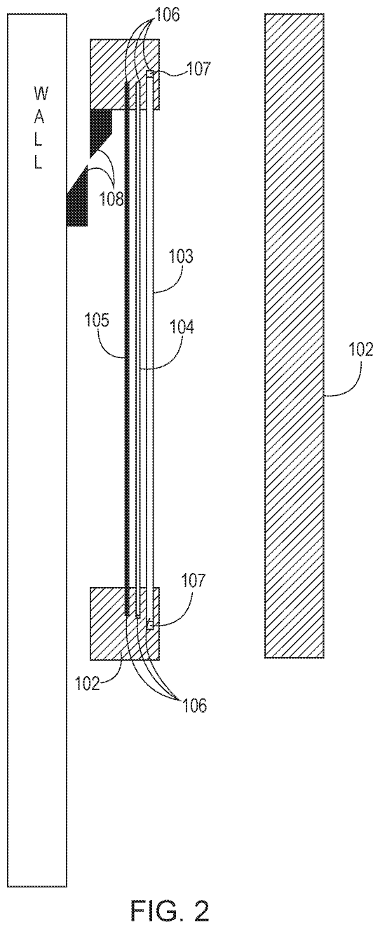

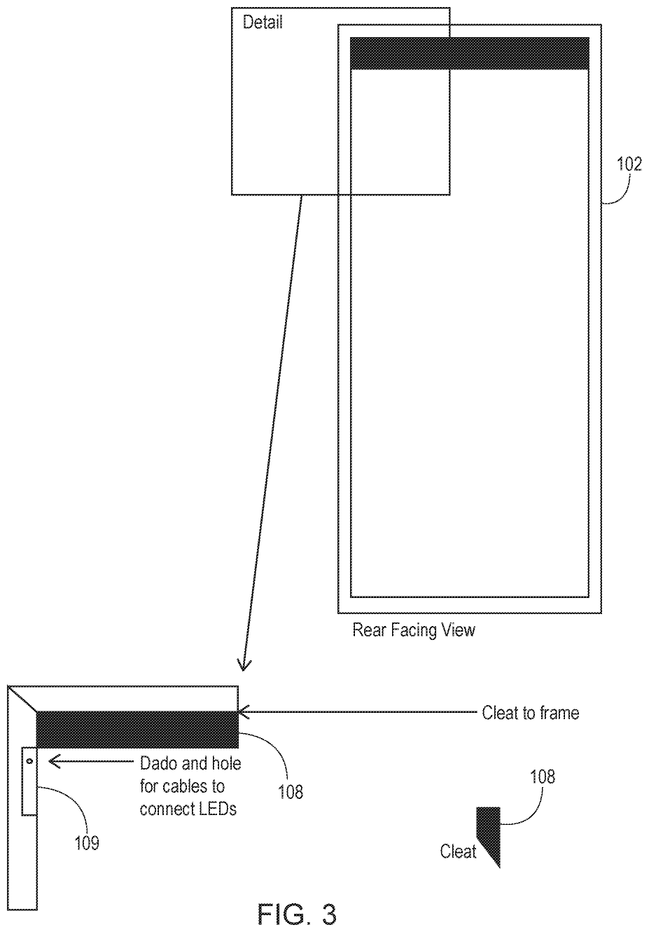

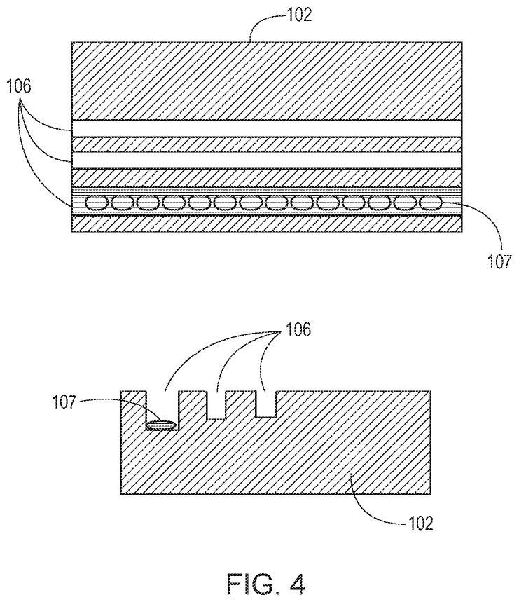

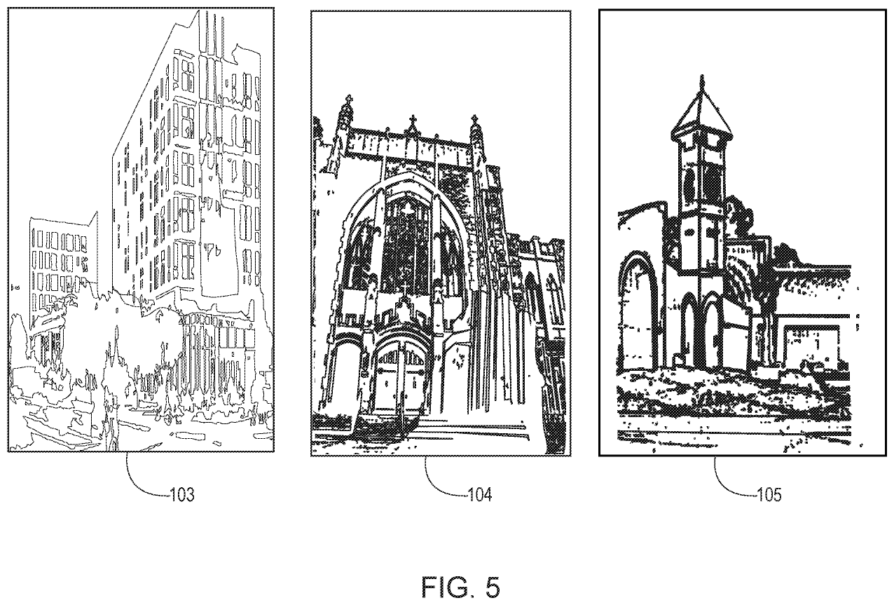

Turning now to the Figures, where are shown the various features of the invention. FIG. 1 shows a lighted image display for artwork 100, the plurality of artwork panels secured in frame 102 (light source not shown). FIG. 2 shows a side view of the lighted image display for artwork 100, showing the side of frame 102, and also a cross section of frame 102 to show the inner channels 106. Light source 107 is secured in the first channel, which also holds the first panel 103; panels 104 and 105 are also shown. An attachment mechanism (here, shown as cleat 108) allows the lighted image display 100 to be mounted, for example to a wall. FIG. 3 shows a rear view of lighted display 100 to show more detail of the hanging mechanism (cleat 108). Part of the cleat attaches to the backside of the frame along the rear top portion. A dado 109 for holding cables and lighting cords is also located on the rear portion of the frame. FIG. 4 shows a cross section of frame 102—both top view and side view—specifically, the channels 106 created on the inner side of the frame in order to secure the artwork panels within the frame when the sides are fully assembled into display 100. Light source 107 is also shown secured within the first channel. FIG. 5 shows a plurality of artwork panels, specifically, a first panel 103, a second panel 104 and a third panel 105. The first and second acrylic panels are transparent. The first panel is laser etched with a thin lines 0.001 to 0.05 inches and all protective cover is removed from the image. The image 103 is visible with the application of light. The key aspect of the lighted panel is allow the illumination of the “invisible image” etched onto the first panel or sheet. The second acrylic sheet is laser etched and paint is applied to the protective cover. The protective cover is removed intentionally, extracting only certain pieces of the painted protective cover that will define the drawing—therefore, a portion of the panel is covered with a painted protective layer, that becomes part of the image itself.

A method of making an image display assembly and illuminating an otherwise invisible layer of an image display comprises: etching an image onto a first acrylic sheet; applying paint to a second sheet, wherein all or a portion of the sheet is covered by a protective layer; removing a portion of the protective layer from the second sheet, whether by tearing or cutting or other manual or mechanical means; and securing the first, second and a third opaque sheet, the opaque sheet being non-transparent by material selection or by color of the sheet, into respective grooves of a partially assembled frame, the frame comprising four side panels (oriented with a top, bottom, and parallel sides), with a plurality of grooves disposed along the inner side of each frame panel, each groove corresponding in thickness to a accommodate a sheet for securement in the frame (for example, a thickness ranging from 1/16 of an inch to ½ of an inch); and upon securement of the sheets into the grooves and arrangement of the top, bottom and sides, attaching each corner of the frame together to form a rectangular image display assembly. The groves may be of varying depths and range from 1/16 to 1 inch in depth, but may vary in order to accommodate a light source within the channel in addition to the sheet. The grooves are applied to each of the four inner walls of the frame sides (top, bottom and each side member of frame).

Features, characteristics, compounds, elements, provided as an embodiment or example of the invention are to be understood to be applicable to any other aspect, embodiment or example described herein unless incompatible therewith. All of the features disclosed in this disclosure (including any accompanying claims, figures, images, pictures), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An image display assembly comprising: a plurality of acrylic sheets wherein at least a first sheet and second sheet are transparent and a third sheet is opaque; the sheets arranged in parallel and spaced a distance from each other so that the sheets do not touch each other on either surface of the sheet the first sheet comprising an image etched thereon; and a frame, herein the frame comprises a plurality of inner channels to secure the image sheets by aligning the image sheets into the channels; and an LED light source secured within a channel of the frame.

2. The assembly of claim 1, wherein the first sheet comprises one of a laser etched image or a painted protective layer, thereon.

3. The assembly of claim 1, wherein the frame has a minimum thickness of 2 inches.

4. A method of making an image display assembly, comprising: etching an image onto a first acrylic sheet; applying paint to a second sheet comprising a portion of the sheet covered by a protective layer; removing a portion of the protective layer from the second sheet; and securing the first, second and a third opaque sheet into grooves of a partially assembled frame, the frame comprising four side panels with a plurality of grooves disposed along the inner side of each frame panel; and forming a rectangular frame when assembled at each corner.

5. The method of claim 2, further comprising, providing a light source for securing into a channel of the frame.
